(19) United States
(12) Patent Application Publication
(10) Pub. No.: US 2006/0212699 A1
(43) Pub. Date: Sep. 21, 2006

(54) Method and apparatus for certifying a design of a software computer program

(76) Inventor: Douglas S. Makofka, Willow Grove, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/321,797

(22) Filed: Dec. 29, 2005

Related U.S. Application Data
(60) Provisional application No. 60/662,572, filed on Mar. 16, 2005.

(51) Int. Cl. H04L 9/00

(52) U.S. Cl. 713/156

(57) ABSTRACT

A software module (SM) is traced from its origin as an abstract design created by a software vendor, through implementation of the abstract design into an executable SM by a software implementer, and up through delivery by the software vendor of the executable SM to a downloading device that will download the executable SM. Prior to downloading, a certification process is used to verify that the executable SM module fulfills the abstract design. Preferably, the certification process also includes an authentication process for authenticating the source of the abstract design.

### CROSS-REFERENCE TO RELATED APPLICATIONS

This application claims priority to the filing date of a U.S. provisional patent application having Ser. No. 60/662,572, entitled “A SYSTEM AND METHOD FOR ENABLING SOFTWARE DESIGN TRACEABILITY CHECKING AT RUNTIME”, filed on Mar. 16, 2005, which is incorporated herein by reference in its entirety.

### TECHNICAL FIELD OF THE INVENTION

The invention relates to software certification. More particularly, the invention relates to associating information with a software program that enables the software program to be traced to a specific design in order to allow a device using the software program to verify that the software program can be traced to a design that is compatible with the intended use of the software program.

### BACKGROUND OF THE INVENTION

The current standard for software certification is provider authentication. In provider authentication models, software is trusted because the provider of the software is trusted. The predominant protocol used to certify software is the X.509 Certificate. An X.509 certificate typically contains a secure ID of the certifying entity and a hash (e.g., SHA-1, MD5) over the software being certified such that the provider of the software can be authenticated using a Trusted Authority in a manner that is well-known in the art. Authentication, in this case, means that the software came from a trusted provider, and the software itself has not been modified.

In some systems, a trustworthy provider is not sufficient to ensure the security and soundness of the overall software environment. For example, an Access Control (AC) subsystem for a Video On Demand (VOD) system permits the downloading of a particular software module (SM) by a client device, which implements a messaging protocol that is used by the client device to access the VOD AC subsystem functions. These AC functions allow access to movies in the VOD system. The VOD service is run by an owner (e.g., a cable television operator or large plain old telephone service (POTS) provider) that uses a 3^{rd} party to manage its VOD system. This 3^{rd} party, as part of its management duties, accepts SM updates for the AC system, certifies them, and downloads them to host devices that control access to the VOD movies.

It is possible that, unbeknownst to the VOD system owner, the 3^{rd} party acts in its own interest to certify a SM that behaves in a manner contrary to the VOD system owner's interests (e.g., allows secret back-doors, enables denial of service, etc.). This SM will be run by the host, since it will pass the authentication test. Thus, in this case, provider authentication is insufficient to ensure that the SM can be trusted.

A similar, but more benign, example is that of a last-minute software change that is included in a SM that, unbeknownst to the developer, is contrary to, or inconsistent with, the proper design/operation of the SM such that it allows unintended behavior in the AC system. This type of scenario can lead to a complete break-down of the AC system.

FIG. 1 illustrates a transaction diagram that depicts the known provider authentication scheme typically used to certify a SM. The downloading device 5 is a host device that will accept and download a SM. The downloading device 5 is expecting that the identity of the provider of the SM, which in this case is the software vendor 4, is the basis of trust for the SM. The software vendor 4 requests an ID from the certifying authority 3, as indicated by arrow 6. The ID is usually in the form of one or more electronic keys represented by one or more series of digital bits. The certifying authority 3 sends an ID to the software vendor 4, as indicated by arrow 7. The software implementer 2, which is typically someone who works for the software vendor 4, completes the SM and delivers the executable SM to the software vendor 4, as indicated by arrow 8. The software vendor 4 requests a certificate for the executable SM from the certifying authority 3, as indicated by arrow 9. This certificate, certA, certifies that the SM actually comes from the software vendor 4. Alternatively, the software vendor 4 may be capable of certifying its own executable SM without communicating with the certifying authority 3.

Assuming the certifying authority 3 is used, it returns the certificate to the software vendor 4, as indicated by arrow 11. The software vendor 4 then sends the executable SM to the downloading device 5 (e.g., a personal computer (PC)), as indicated by arrow 12. The software vendor 4 then sends the certificate to the downloading device 5, as indicated by arrow 13. The steps represented by arrows 12 and 13 are sometimes combined.

It should be noted that there is no authenticated relationship between the SM executable presented to the software vendor 4 by the software implementer 2 and the SM that is eventually downloaded to the downloading device 5. If, for example, the software vendor 4 switched the implementer-supplied SM with another SM, this other SM would be the one certified rather than the implementer-supplied. It should also be noted that there is not any connection between the behavior that the downloading device 5 is expecting from the SM and the actual behavior of the downloaded SM. Therefore, successful provider authentication does not ensure that the behavior of the SM received by the downloading device 5 can be trusted. Consequently, the certifying technique represented by the transaction diagram shown in FIG. 1 is not sufficient to ensure that a SM to be downloaded by a downloading device will behave in the manner expected by the downloading device.

A need exists for a way to certify a SM that ensures that the behavior of the SM can be trusted.

### BRIEF DESCRIPTION OF THE DRAWINGS

FIG. 1 illustrates a transaction diagram that demonstrates a known method for certifying a SM.

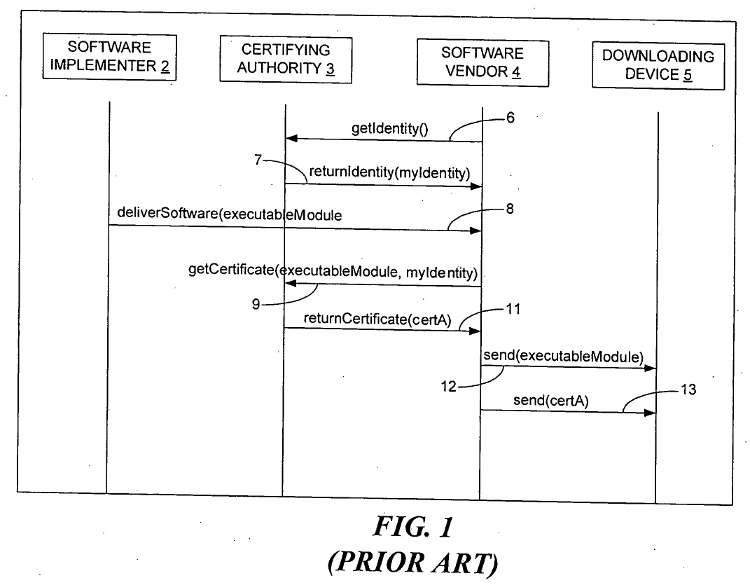

FIG. 2 illustrates a transaction diagram that demonstrates the manner in which the invention certifies a SM in accordance with an exemplary embodiment.

FIG. 3 illustrates a flowchart that demonstrates the method of the invention in accordance with an exemplary embodiment performed by the certifying authority.

FIG. 4 illustrates a flowchart that demonstrates the method of the invention in accordance with an exemplary embodiment performed by the software vendor.

FIG. 5 illustrates a flowchart that demonstrates the method of the invention in accordance with an exemplary embodiment performed by the software implementer.

FIG. 6 illustrates a flowchart that demonstrates the method of the invention in accordance with an exemplary embodiment performed by the downloading device.

FIG. 7 illustrates the apparatus of the invention in accordance with an exemplary embodiment for performing the certifying authority functions.

FIG. 8 illustrates the apparatus of the invention in accordance with an exemplary embodiment for performing the software vendor functions.

FIG. 9 illustrates the apparatus of the invention in accordance with an exemplary embodiment for performing the software implementer functions.

FIG. 10 illustrates the apparatus of the invention in accordance with an exemplary embodiment for performing the downloading device functions.

### DETAILED DESCRIPTION OF THE INVENTION

In accordance with the invention, a SM is traced from its origin to an abstract design created by a software vendor or other entity, which specifies the intended behavior of the SM. A certification process is used to verify that the executable SM module fulfills the abstract design by associating the trace with the executable SM. Preferably, the certification process also includes an authentication process for authenticating the source of the abstract design.

In accordance with one exemplary embodiment of the invention, a tool is provided that allows a software vendor to “self certify” a SM against a specific abstract design, or other statement of software correctness. For example, an Audio/Video (A/V) player permits and requires downloadable CODEC SMs. These CODEC SMs participate in a chain that restricts access to A/V media based on access rights. The manufacture of the player operates a certification/testing process to be sure that the CODECs obey the access rights criteria (e.g., not directing the CODEC SM output to a hard disk on “watch-only” content). To get authentication credentials for its CODEC SM, a software vendor must go through the certification process. Assuming that this A/V player becomes so popular, that thousands of vendor/CODEC combinations need to be tested. This could cause the certification/testing process described above with reference to FIG. I to breakdown, as CODECS might not be capable of being sent through the certification process fast enough. As a result, the CODECs could become obsolete before authentication credentials can be obtained for them. The invention solves problems of this type by providing a tool that automatically runs the verification process against a candidate SM, and generates a certificate for a SM that passes the verification process.

A “trace”, as that term is used herein, is intended to denote information that is created and passed between entities involved in the process of creating the abstract design, implementing an executable SM that is based on the abstract design, verifying and authenticating the executable SM, and delivering the executable SM to a downloading device (e.g., a PC). All or part of the trace may be used to certify that the SM that is ultimately delivered to the downloading device is an appropriate SM, i.e., will behave in the manner expected by the downloading device. At a minimum, a “trace” includes a reference to the abstract design or some other statement of the intended behavior of the SM, a digital hash or signature of the downloadable image of the SM, and the trace relationship between the SM and the abstract design. The trace relationship is typically one or more of: (1) an indication that a responsible person has verified that the SM behaves as required by the abstract design; (2) an indication from an “implementation tool” that the SM was correctly generated from the abstract design using code generation techniques known in the art; and (3) an indication that the SM was tested and passed the test. This test-passing indication can come from a responsible person, or from a “certifying tool”. In each case, the “indication” is an “authenicatable” digital representation, such as, for example, a certificate signed using a secure digital key.

The term “abstract design”, as that term is used herein, is intended to mean any statement that describes the behavior of the resulting SM, which may be a statement written in a human-readable language (e.g., English, Japanese, etc.) that expresses in words the intended behavior of the resulting SM, or a statement written in a computer language that expresses the intended behavior of the resulting SM with computer instructions (e.g., source code, object code, etc.). The term “statement”, as that term is used herein, is intended to mean any expression of the intended behavior of the SM. The expression may be a general expression (i.e., high level) or a detailed expression (i.e., low level), or an expression that is somewhere in between a general expression and a detailed expression. For example, an abstract design may be a high-level design written in Unified Modeling Language (UML) or Specification and Description Language (SDL). Preferably, the software implementer will use a tool that automatically generates the SM low-level design and code from the high-level design. Computer languages other than UML and SDL may also be used to describe the abstract design (e.g., SystemC, RTL, etc.).

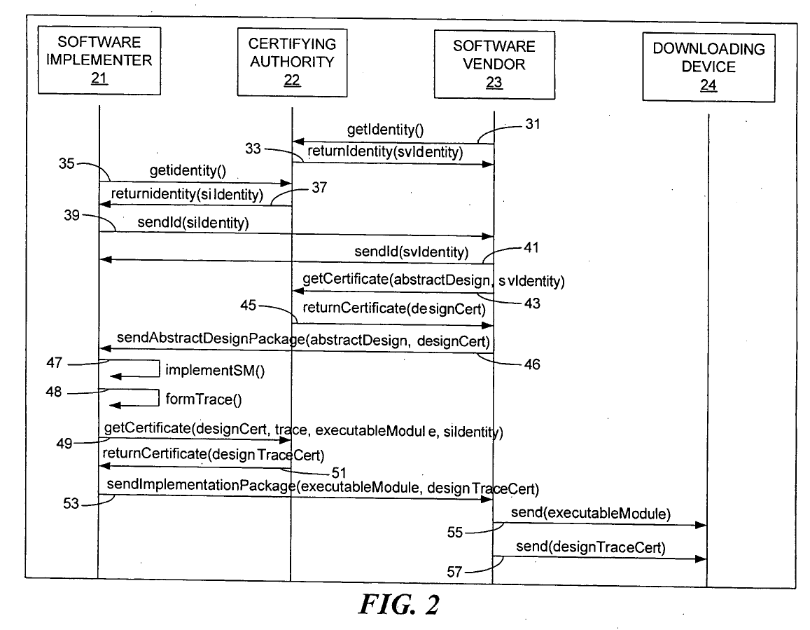

FIG. 2 illustrates a transaction diagram of the certification process of the invention in accordance with an exemplary embodiment. A software vendor 23 requests an authenticated identification (ID) from the certifying authority 22, as indicated by arrow 31. This ID will be referred to herein as “svIdentity”. The certifying authority 22 then returns the svIdentity to the software vendor 23, as indicated by arrow 33. This ID is typically a unique digital key or key pair, as is known in the art. The software implementer 21 also requests an ID from the certifying authority, as indicated by arrow 35. This ID will be referred to herein as “svIdentity”. The certifying authority 22 then returns the svIdentity to the software implementer 21, as indicated by arrow 37. This ID is also a unique digital key or key pair. In accordance with the preferred embodiment, the software implementer 21 obtains a secure identity for the individual that will be allowed to claim, on behalf of the software implementer, that the SM behaves as required by the abstract design. This ID is referred to as “taldentity” (for Trace Authority Identity).

The software implementer 21 sends the svIdentity to the software vendor 23, as indicated by arrow 39. Likewise, the software vendor 23 sends the svIdentity to the software implementer 21, as indicated by arrow 41. It should be noted that the software vendor 23 and the software implementer 21 may be the same entity, in which case one ID is used twice.

The software vendor 23 then requests a certificate for the abstract design from the certifying authority 22, as indicated by arrow 43. This request includes the svIdentity and the abstract design. The svIdentity included in the certification request binds the abstract design to the software vendor 23. The certifying authority 22 generates a certificate for the abstract design, and returns the certificate to the software vendor 23, as indicated by arrow 45. The certificate returned to the software vendor 23 is referred to herein as the “designCert”. The designcert certificate typically contains a digital signature generated by processing the bits that make up the abstract design and the svIdentity in accordance with a particular algorithm (e.g., a hash algorithm such as MD5). This certificate authenticates that the abstract design came from the software vendor 23.

The software vendor 23 sends the abstract design and the designCert to the software implementer 21, as indicated by arrow 46. The software implementer 21 then implements the SM, as indicated by arrow 47. After implementation of the SM, the software implementer 21 forms the trace, as indicated by arrow 48. The trace formed by the software implementer 21 certifies that the SM behaves as required by the abstract design. The software implementer 21 then sends a request for a design trace certificate to the certifying authority 22, as indicated by arrow 49. This request includes the designCert, the executable SM, the trace, and the svIdentity. The certifying authority 22 processes the bits that make up the designcert, the executable SM, the svIdentity, and the trace in accordance with a particular algorithm (e.g., a hash algorithm) to generate a design trace certificate, which is referred to herein as “designTraceCert”.

The certifying authority 22 sends the designTraceCert to the software implementer 21, as indicated by arrow 51. The executable SM and the designTraceCert are then sent by the software implementer 21 to the software vendor 23, as indicated by arrow 53. The software vendor 23 then sends the executable SM and the designTraceCert to the downloading device 24, as indicated by arrows 55 and 57. The executable SM and the designTraceCert may be sent separately or together. The downloading device 24 uses the designTraceCert to authenticate the intended behavior of the executable SM. Authentication, in this case, means that the downloading device 24 has received a trace (contained in the designTraceCert) that is associated with an acceptable abstract design for the downloaded SM.

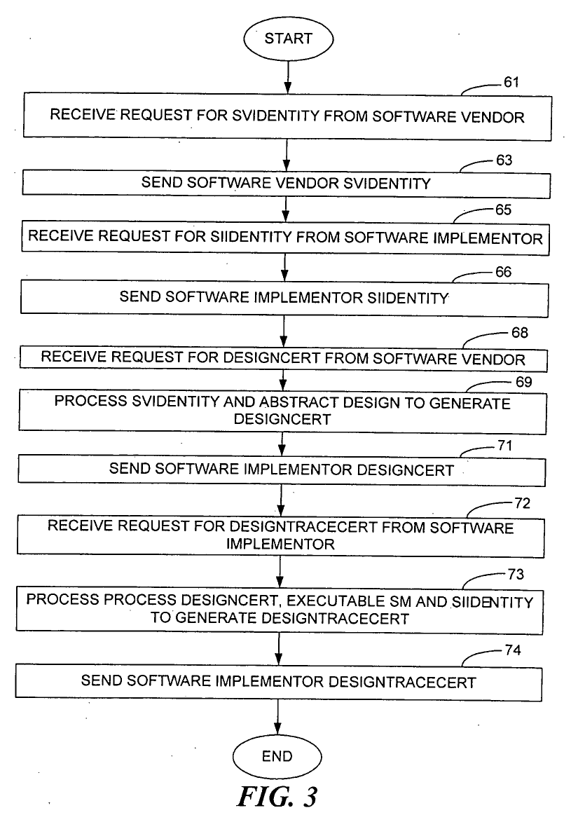

FIG. 3 illustrates a flowchart that demonstrates the method performed by the certifying authority in accordance with an exemplary embodiment. The certifying authority receives the request for an svIdentity from the software vendor, as indicated by block 61. The certifying authority sends the svIdentity to the software vendor, as indicated by block 63. The certifying authority receives the request for an svIdentity from the software implementer, as indicated by block 65. The certifying authority sends the svIdentity to the software implementer, as indicated by block 66. It should be noted that it is not necessary for the steps represented by blocks 61-66 to be performed in the order shown in FIG. 3. For example, the software implementer may request and receive the svIdentity prior to the software implementer requesting and receiving the svIdentity. Also, as described above with reference to FIG. 2, the software vendor and the software implementer may be the same entity, in which case only a single ID is obtained from the certifying authority.

The certifying authority receives a request for designCert from the software vendor, as indicated by block 68. As described above with reference to FIG. 2, this request includes the abstract design and the svIdentity, which the certifying authority processes to generate the designcert, as indicated by block 69. The certifying authority sends the designcert to the software vendor, as indicated by block 71. The certifying authority receives a request for designTraceCert from the software implementer, as indicated by block 72. As described above with reference to FIG. 2, this request includes the designCert, the executable SM and the svIdentity, which the certifying authority processes to generate the designTraceCert, as indicated by block 73. The certifying authority sends the designTraceCert to the software implementer, as indicated by block 74.

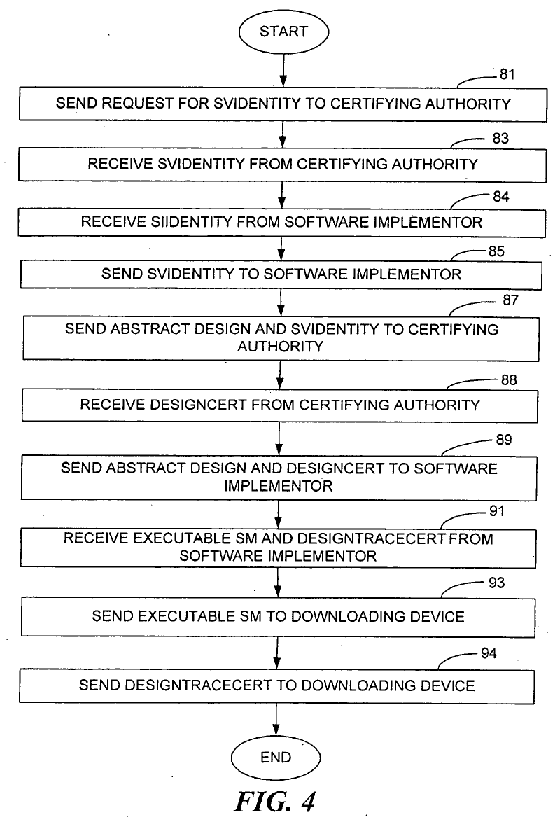

FIG. 4 illustrates a flowchart of the method of the invention performed by the software vendor in accordance with an exemplary embodiment. The software implementer sends a request for the svIdentity to the certifying authority, as indicated by block 81. The software vendor receives the svIdentity from the certifying authority, as indicated by block 83. The software vendor receives the svIdentity from the software implementer, as indicated by block 84. The software implementer sends the svIdentity to the software implementor, as indicated by block 85. The software vendor sends a request for designCert to the certifying authority, as indicated by block 87. As described above with reference to FIG. 2, the request includes the abstract design produced by the software vendor and the svIdentity. The certifying authority processes the abstract design and the svIdentity in the manner described above with reference to FIG. 2 and returns the designCert to the software vendor. The software vendor receives the designCert, as indicated by block 88. [00331 The software vendor sends the designCert and the abstract design to the software implementer, as indicated by block 89. The software implementer produces an executable SM that is based in the abstract design and forwards the executable SM to the certifying authority along with the svIdentity, which the certifying authority processes to generate the designTraceCert. The certifying authority sends the designTraceCert to the software implementer, which then sends the encrypted SM executable and the designTraceCert to the software vendor.

The software vendor receives the designTraceCert and the encrypted SM from the software implementer, as indicated by block 91. The software vendor sends the encrypted executable SM to the downloading device, as indicated by block 93. The software vendor sends the designTraceCert to the downloading device, as indicated by block 94.

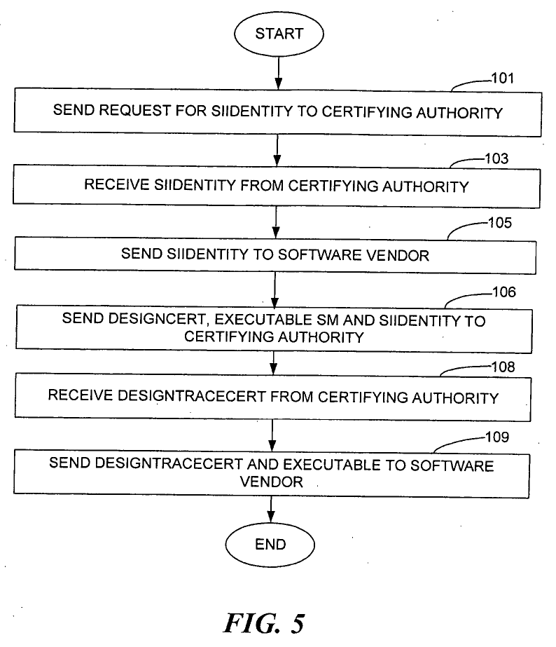

FIG. 5 illustrates a flowchart of the method of the invention in accordance with an exemplary embodiment performed by the software implementer. The software implementer sends a request for the svIdentity to the certifying authority, as indicated by block 101. The certifying authority returns the svIdentity to the software implementer. The software implementer receives the svIdentity, as indicated by block 103. The software implementer sends the svIdentity to the software vendor, as indicated by block 104. The software implementer receives the svIdentity from the software vendor, as indicated by block 105. In the request for the designTraceCert, the software implementer sends the designcert, the executable SM and the svIdentity to the certifying authority, as indicated by block 106. The software implementer receives the designTraceCert from the certifying authority, as indicated by block 108. The software implementer sends the executable SM and the designCertTrace to the software vendor, as indicated by block 109.

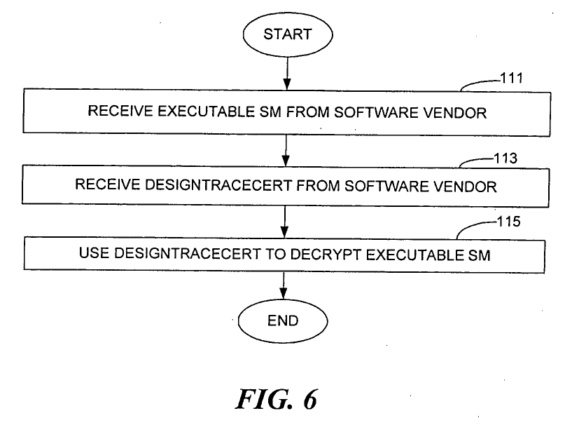

FIG. 6 illustrates a flowchart of the method of the invention in accordance with an exemplary embodiment performed by the downloading device. The downloading device receives the executable SM from the software vendor, as indicated by block 111. The downloading device receives the designTraceCert from the software vendor, as indicated by block 113. The downloading device uses the designTraceCert to decrypt the executable SM, as indicated by block 115.

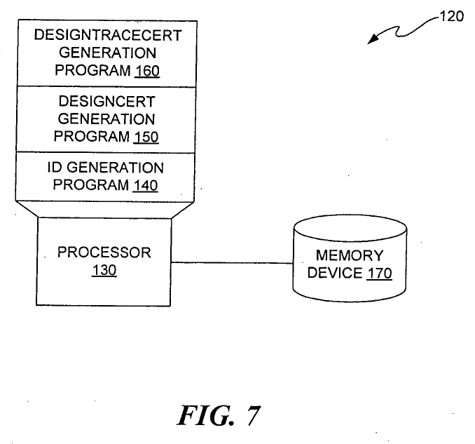

FIG. 7 illustrates a block diagram of the apparatus 120 of the invention in accordance with an exemplary embodiment for performing the certifying authority functions. The apparatus 120 includes a processor 130 that is programmed to execute an ID generation software program 140, a designcert generation software program 150 and a designTraceCert generation software program 160. The apparatus 120 typically also includes a memory device 170 for storing software programs and data.

The ID generation program 140 receives the ID requests from the software vendor and software implementer, generates the svIdentity and the svIdentity, and causes them to be sent to the software vendor and software implementor. The designcert program 150 receives the abstract design and the svIdentity from the software vendor and processes the corresponding bits to generate the designCert, which it then causes to be sent to the software vendor. The designTraceCert program 160 receives the designCert, the executable SM and the svIdentity from the software implementer and processes the corresponding bits to generate the designTraceCert, which it then causes to be sent to the software implementor.

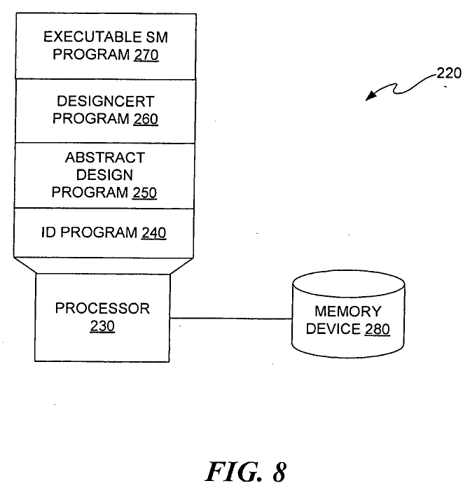

FIG. 8 illustrates a block diagram of the apparatus 220 of the invention in accordance with an exemplary embodiment for performing the software vendor functions. The apparatus 220 includes a processor 230 that is programmed to execute an ID software program 240, an abstract design software program 250, a designcert software program 260, and an executable SM transmission software program 270. The apparatus 220 typically also includes a memory device 280 for storing software programs and data.

The ID program 240 obtains the svIdentity from the certifying authority, receives the svIdentity from the software implementer, and sends the svIdentity to the software implementor. The abstract design program 250 is a program used by to create the abstract design that is later used by the software implementer to create the executable SM. The designcert program 260 sends the abstract design and the svIdentity to the certifying authority, receives the designcert from the certifying authority, and sends the abstract design and the designCert to the software implementer. The executable SM program 270 receives the executable SM and the designTraceCert from the software implementer and sends them to the downloading device.

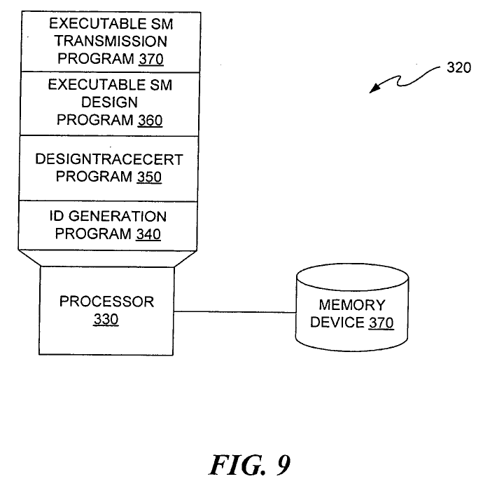

FIG. 9 illustrates a block diagram of the apparatus 320 of the invention in accordance with an exemplary embodiment for performing the software vendor functions. The apparatus 320 includes a processor 330 that is programmed to execute an ID software program 340, a designTraceCert software program 350, an executable SM design software program 360, and an executable SM transmission software program 370. The apparatus 320 typically also includes a memory device 380 for storing software programs and data.

The ID program 340 obtains the svIdentity from the certifying authority, receives the svIdentity from the software vendor, and sends the svIdentity to the software vendor. The designTraceCert program 350 receives the abstract design and the designcert from the software vendor. The executable SM design program 360 creates the executable SM based on the abstract design. The designTraceCert program 350 sends the executable SM and the svIdentity to the certifying authority in the request for designTraceCert. The executable SM transmission program 370 sends the executable SM and the designTraceCert to the software vendor.

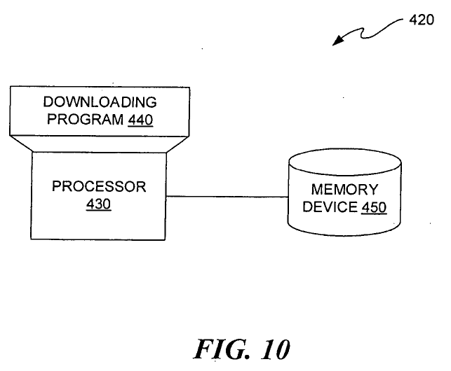

FIG. 10 illustrates a block diagram of the apparatus 420 of the invention in accordance with an exemplary embodiment for performing the downloading device functions. The apparatus 420 includes a processor 430 that is programmed to execute a downloading software program 440. The apparatus 420 typically also includes a memory device 450 for storing software programs and data. The downloading program 440 receives the executable SM and the designTraceCert from the software vendor and uses the designTraceCert to decrypt the executable SM.

It should be noted that the software programs described above with reference to FIGS. 7-10 are examples of programs that may be used to perform the functions associated with the corresponding entity. It should also be noted that although the functions described above with reference to FIGS. 7-10 have been described as being performed in software, they may instead be performed solely in hardware or in a combination of hardware and software. When the functions are implemented in software, the programs are stored in the memory devices shown in FIGS. 7-10 or in some other computer-readable mediums. Any type of computer-readable medium may be used for these purposes, such as, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc.) in packets and in non-packet formats. The processors shown in FIGS. 7-10 may be any type of computational devices including, for example, microprocessors, application specific integrated circuits (ASICs), microcontrollers, logic gate arrays, etc.

In accordance with the preferred embodiment, the functions of the invention described above with reference to FIGS. 2-10 are implemented by respective tools of a tool set. However, it should be noted that it is possible that a single tool could perform all of the functions. In accordance with the preferred embodiment, a context tool manages contexts for the system vendor. The term “context”, as that term is used herein, refers to a set of abstract designs and software modules. A system specification tool is used to create an abstract design. An implementer tool is used to implement the SM based on the abstract design, and to form the trace between the abstract design and the SM. A deployment tool is used to cause a specific context scenario to take affect in a target system.

It should be noted that the invention has been described with reference to exemplary and preferred embodiments. The invention is not limited to the embodiments described herein. Those skilled in the art will understand, in view of the description provided herein, the manner in which variations may be made to the embodiments described herein, and that all such variations are also within the scope of the invention.

What is claimed is:

1. A method for authenticating a software module (SM), the method comprising:
associating a design trace certificate (designTraceCert) with a SM that certifies that the SM behaves in a manner that is consistent with an abstract design.

2. The method of claim 1, wherein associating the designTraceCert with the SM includes:
receiving an abstract design for the SM, the abstract design being a statement that expresses an intended behavior of the SM;
receiving an abstract design certificate (designCert); and
processing the abstract design and the designcert to generate a trace.

3. The method of claim 2, wherein associating the designTraceCert with the SM further comprises:
obtaining an identity from a certifying authority;
implementing a SM that is based on the received abstract design;
sending the SM, the designcert, the trace, and the identity to the certifying authority; and
receiving the designTraceCert from the certifying authority.

4. The method of claim 3, further comprising:
sending the designTraceCert and the SM to a downloading device.

5. The method of claim 1, wherein associating a design trace certificate (designTraceCert) with a SM includes:
creating an abstract design for a SM, the abstract design being a statement that expresses an intended behavior of the SM;
requesting an identity from a certifying;
receiving an identity from a certifying authority;
sending a request for an abstract design certificate (designcert) to the certifying authority, the request for the abstract design including the abstract design and the identity; and
receiving the requested designCert from the certifying authority.

6. The method of claim 1, wherein associating a design trace certificate (designTraceCert) with a SM includes:
receiving a request for an identity from a requesting entity;
sending the requested identity to the requesting entity;
receiving a request for an abstract design certificate (designcert) from the requesting entity, the request including the identity and an abstract design;
processing the received abstract design and the identity to produce the designCert; and
sending the designCert to the requesting entity.

7. The method of claim 1, wherein associating a design trace certificate (designTraceCert) with a SM includes:
receiving a request for the designTraceCert from a requesting entity, the request including an abstract design certification (designCert), a SM to be authenticated, a trace and an identity of the requesting entity, the designcert certifying an abstract design, the abstract design being a statement that expresses an intended behavior of the SM to be authenticated;
processing the designcert, the SM to be authenticated, the trace, and the identity to produce the designTraceCert; and
sending the designTraceCert to the requesting entity.

8. A computer program for authenticating a software module (SM), said computer program being embodied in a computer-readable medium, the program including instructions for execution by a computer, the instructions comprising:
instructions for associating a design trace certificate (designTraceCert) with a SM that certifies that the SM behaves in a manner that is consistent with an abstract design.

9. The computer program of claim 8, wherein the instructions for associating the designTraceCert with the SM include:
instructions for receiving an abstract design for the SM, the abstract design being a statement that expresses an intended behavior of the SM;
instructions for receiving an abstract design certificate (designCert); and
instructions for processing the abstract design and the designCert to generate a trace.

10. The computer program of claim 9, wherein the instructions for associating the designTraceCert with the SM further include:
instructions for obtaining an identity from a certifying authority;
instructions for implementing a SM that is based on the received abstract design;
instructions for sending the SM, the designCert, the trace, and the identity to the certifying authority; and
instructions for receiving the designTraceCert from the certifying authority.

11. The computer program of claim 10, further comprising:
instructions for sending the designTraceCert and the SM to a downloading device.

12. The computer program of claim 8, wherein the instructions for associating a design trace certificate (designTraceCert) with a SM include:
instructions for creating an abstract design for a SM, the abstract design being a statement that expresses an intended behavior of the SM;
instructions for requesting an identity from a certifying;
instructions for receiving an identity from a certifying authority;
instructions for sending a request for an abstract design certificate (designcert) to the certifying authority, the request for the abstract design including the abstract design and the identity; and
instructions for receiving the requested designcert from the certifying authority.

13. The computer program of claim 8, wherein the instructions for associating a design trace certificate (designTraceCert) with a SM include:
instructions for receiving a request for an identity from a requesting entity;
instructions for sending the requested identity to the requesting entity;
instructions for receiving a request for an abstract design certificate (designcert) from the requesting entity, the request including the identity and an abstract design;
instructions for processing the received abstract design and the identity to produce the designcert; and
instructions for sending the designCert to the requesting entity.

14. The computer program of claim 13, wherein the instructions for associating a design trace certificate (designTraceCert) with a SM include:
instructions for receiving a request for the designTraceCert from a requesting entity, the request including an abstract design certification (designCert), a SM to be authenticated, a trace and an identity of the requesting entity, the designCert certifying an abstract design, the abstract design being a statement that expresses an intended behavior of the SM to be authenticated;
instructions for processing the designcert, the SM to be authenticated, the trace, and the identity to produce the designTraceCert; and
instructions for sending the designTraceCert to the requesting entity.

15. An apparatus for authenticating a software module (SM), the apparatus comprising:
a processor configured to associate a design trace certificate (designTraceCert) with a SM that certifies that the SM behaves in a manner that is consistent with an abstract design.

16. The apparatus of claim 15, wherein the processor associates the designTraceCert with the SM by:
receiving an abstract design for the SM, the abstract design being a statement that expresses an intended behavior of the SM;
receiving an abstract design certificate (designCert); and
processing the abstract design and the designcert to generate a trace.

17. The apparatus of claim 15, wherein the processor associates the designTraceCert with the SM by:
receiving an abstract design for the SM, the abstract design being a statement that expresses an intended behavior of the SM;
receiving an abstract design certificate (designCert); and
processing the abstract design and the designcert to generate a trace obtaining an identity from a certifying authority;
implementing a SM that is based on the received abstract design;
sending the SM, the designcert, the trace, and the identity to the certifying authority;
receiving the designTraceCert from the certifying authority; and
sending the designTraceCert and the SM to a downloading device.

18. The apparatus of claim 15, wherein the processor associates the designTraceCert with the SM by:
creating an abstract design for a SM, the abstract design being a statement that expresses an intended behavior of the SM;
requesting an identity from a certifying;
receiving an identity from a certifying authority;
sending a request for an abstract design certificate (designcert) to the certifying authority, the request for the abstract design including the abstract design and the identity; and
receiving the requested designcert from the certifying authority.

19. The apparatus of claim 15, wherein the processor associates the designTraceCert with the SM by:
receiving a request for an identity from a requesting entity;
sending the requested identity to the requesting entity;
receiving a request for an abstract design certificate (designCert) from the requesting entity, the request including the identity and an abstract design;
processing the received abstract design and the identity to produce the designcert; and
sending the designcert to the requesting entity.

20. The apparatus of claim 15, wherein the processor associates the designTraceCert with the SM by:
receiving a request for the designTraceCert from a requesting entity, the request including an abstract design certification (designCert), a SM to be authenticated, a trace and an identity of the requesting entity, the designcert certifying an abstract design, the abstract design being a statement that expresses an intended behavior of the SM to be authenticated;
processing the designCert, the SM to be authenticated, the trace, and the identity to produce the designTraceCert; and
sending the designTraceCert to the requesting entity.
